(19) United States
(12) Patent Application Publication
(10) Pub. No.: US 2015/0081042 A1
(43) Pub. Date: Mar. 19, 2015

(54) INTELLIGENT INTERACTIVE CONTROL SYSTEM FOR ELECTRICAL DEVICES

(71) Applicant: Ivan Araujo Dayrell, Belo Horizonte (BR)

(72) Inventor: Ivan Araujo Dayrell, Belo Horizonte (BR)

(21) Appl. No.: 14/480,290

(22) Filed: Sep. 8, 2014

Related U.S. Application Data
(60) Provisional application No. 61/877,753, filed on Sep. 13, 2013.

(51) Int. Cl. G05B 13/02

(52) U.S. Cl. CPC G05B 13/02
USPC 700/17; 700/22; 700/19

(57) ABSTRACT

An intelligent interactive control system for lighting, appliances, office equipment, medical equipment, and other devices that provides for information to be exchanged in such a way that the devices can be made to operate according to a configurable way that may vary over time and according to the environment and power supply situation to save energy and increase safety.

### CROSS REFERENCE TO RELATED APPLICATIONS

This application claims the benefit of U.S. Provisional Application No. 61/877,753 filed Sep. 13, 2013 entitled Intelligent Interactive Control System for Electrical Devices which is hereby incorporated by reference in its entirety.

### FIELD OF THE INVENTION

The present invention is related to an intelligent interactive control system consisting of a control unit, and an interactive unit that is connected to or integrated with an electrical device to control electrical power and to program the use of power by the device to provide interactive lighting, and control appliances, office equipment, medical equipment and other electrical devices The interactive control system may further have actuator units that provide for information to be exchanged with the interactive devices in such a way that they can be made to operate according to a configurable way that may vary over time and according to the environment and power supply situation to save energy and increase safety.

### BACKGROUND

A lot of effort has been channeled recently into developing new energy efficient equipment as a means to save energy and reduce the ecological impact mankind has on the environment. This effort has been paralleled by a constant increase in the price of energy that gives residential, industrial and even government users an incentive to reduce energy consumption and by doing so save money.

Among the several possibilities available, one that has been gaining momentum is replacing old technology lamps, appliances, office equipment, medical equipment and other electrical devices with new ones that offer similar performance and provide a substantial reduction in electricity consumption. As an example, recently developed light-emitting diode (LED) lamps are basically made from an array of semiconducting LED devices assembled together with other necessary electronic components to deliver similar performance as traditional lamps and at the same time allow the user to save a substantial amount of the energy. Because LED lamps need to have a lot of electronics built in the units, it is possible for the manufacturers to pack in additional control circuits at a very small incremental cost and offer additional features that may give them an edge on an increasingly competitive market and help customers to decide on the replacement for their particular product. Although the main incentive remains the energy savings, all favorable features, both those naturally inherent to the new technology and wherever the case, the additionally added functions add up to a number of advantages for the customers to consider when deciding whether or not to replace old lamps.

A simple list of features currently seen on the market are:
1. Reduced power consumption.
2. Less heat production.
3. Ability to dim the light to any desired level.
4. Smaller size and weight allowing for new possible applications.
5. Better resistance to vibration and mechanical shock.
6. Increased reliability and life span.
7. Ability to operate within a brighter range of voltages and frequencies avoiding damage from improper use or fluctuations in the electric supply.
8. Ability to vary light color and brightness (temperature).
9. Other special features that may be available such as integrated motion sensors, remote control, etc.

Although this may appear to be an impressive array of advantages, the initial cost of the lamps remains a barrier preventing the rapid adoption of the new technology, and even more so when the user already has a high number of old units installed.

Many control units have been available to produce all sorts of light displays in commercial or residential environments. Mostly these units are used for a special purpose such as to highlight a particular object or area or for a specific event such as Christmas, New Year, or special commemorative days, for example. These units are normally made to order by expert technicians or in some cases mass produced by manufacturers for example for Christmas lights, sequential lights and so on. For home and office use, some companies offer sophisticated electronic switches that allow the user to switch on and off or dim the lights. These must be installed replacing the old traditional on/off switches and are normally considerably more expensive. Also some of these high end switches can interface to a remote control unit allowing the user to control all lights in a room or region with a remote control unit. Some units offer the possibility to program on and off times and simulate presence in the house as a means to increase user comfort or deter burglary. These units remain though as an add-on to the lamps and do not really integrate to the lamps or alter them in a substantial way. The lamps remain basically just simple devices that can only be switched on or off. In the event that the external controller is bypassed, the lamps will simply operate as normal lamps reducing the possible applications of the controller. Other newer designs for appliances, office equipment and medical equipment also provide reduced power consumption and other features that may be optimized even further using the intelligent interactive controls of the present invention.

### SUMMARY OF THE INVENTION

A new interactive control system consisting of a control unit, remote interactive units and programmable actuator units is proposed. This system allows information to be exchanged between the control unit, programmable actuator and the remote interactive units in such a way that lights, appliances, office equipment, medical equipment and other electrical devices can be made to operate according to a configurable way that may vary both over time and according to the environment and that controls the supply and power output to save energy and increase safety.

The system can operate with only interactive units and/or programmable actuators in a manual configuration mode or if one or more controllers are used in an enhanced mode offering additional functionalities. The system can operate autonomously and does not require constant user intervention. Users can implement multiple configuration schemes suitable for their needs and comfort. Different configurations can be made to maximize savings, comfort or safety taking into account multiple factors such as the season of the calendar year, the time of day, the cost of electricity at peak hours and off peak hours, and other conditions based upon operational settings or requirements. The system can be configured to automatically switch between different configurations according to external factors such as a power failure, a burglary alarm, or a fire alarm, for example.

The remote interactive units have embedded control circuitry used in implementing the technology of the present invention. This embedded control circuitry causes no significant cost increase to the lamps, appliances, office equipment, medical equipment or other electrical devices and if the user so wishes the electrical device can still be used in a normal stand-alone mode without any communication with a controller or actuator so that if no configuration setting program is made the lamps, appliances, office equipment and medical equipment simply behave as normal devices. The added embedded circuitry for a lamp may be installed, for example, in housings suitable for replacement in incandescent, fluorescent, halogen, LED or other lighting configurations. The current invention creates a fundamental improvement over the way the devices can be controlled and deployed and therefore reduces the resistance of users to replace their old lamps or appliances with new ones. The new features provide new ways for users to benefit from the interactive units and it is expected that even users that already have replaced old lamps with newer more efficient bulbs may decide to upgrade to new ones using the proposed technology to benefit from the new possibilities offered.

One of the objects of the present invention is the control of multiple interactive units individually or collectively. This can be used for practical purposes for example to switch off all lamps, computers, copiers, and other equipment in an office or building after work hours from a single point or from a computer, smartphone, tablet or other digital device. It can also be used for special purposes for example to set up special effects using an interactive unit integrated with a lighting system to produce moving or static patterns or even text messages on a tall building façade for advertising, Christmas or other special occasions.

An object of the invention is the reduction or increase in lamp power output (luminosity) according to a custom pattern or program to improve power savings (for example varying power according to daytime or night time in an office or reducing power during lunch time).

Another object of the invention is the ability to control the interactive units without the necessity of traditional physical switches that interrupt the electrical current to the units. In this way physical switches can be removed altogether from the building installation reducing installation costs and construction time, improving aesthetics of the rooms and facilitating room rearrangements at a later time. The interactive units can be relocated to other places simply by moving them without the need to reroute wires. Programmable interactive control units can be easily placed at any convenient location and be programmed to activate, dim, deactivate or perform other operations on one or more lamps of an interactive unit lighting system or operation of an appliance according to user convenience.

A further object of the invention is the ability to produce random yet consistent illumination patterns in a building to simulate human presence as a means to deter burglary. The interactive lighting system units may be preprogrammed or be controlled remotely over the internet from anywhere using a computer or smart phone. Using this feature, in conjunction with a web cam, a user will be able for example to check the status of pets or presence of intruders in his home anytime, switching on lights at night if necessary only during the time he needs to watch the images.

A still further object of the invention is in case of power loss if an emergency backup generator and/or a no break battery operated system is available the system automatically adjusts power consumption switching off all non-essential lamps and/or dimming the ones switched on according to a previous programmable configuration or based on the time of day to manage the situation as well as possible. This allows the home, office or factory where the system is installed to easily implement an emergency lighting system without the need of making big and costly modifications to the electrical installation. Lamps with batteries used for emergency illumination can also be fitted with the interactive technology allowing them to communicate with the controller so that critical information such as battery charge and quality of the lighting system, such as through hours of usage can be easily made available.

A still further object of the invention is the configuration of special illumination profiles for seasons of the year, special occasions or emergencies such as summer/winter time, anniversaries, Christmas, New Year as well as fire, burglary detected, power fluctuations, or other conditions or events.

The present invention can further control power consumption and produce consumption reports indicating current and projected consumption over a period of time. The present invention further automatically detects all interactive lighting system units connected within an area and reports degraded luminosity or defective components that need replacement.

A still further benefit of the interactive lighting system units is the ability for a user to easily program intended time for each unit to be lit after triggered manually or by a presence sensor.

The interactive control system further opens the possibility for new business models involving lighting and electrical systems. For example, a company could purchase the interactive control system for a customer or other third party, program the interactive units according to the customer wishes and necessity and install them at an office or factory. Instead of purchasing the interactive units immediately the final customer could agree with the supplying company specific conditions to receive the units such as signing a long term lease contract or pay for the installation in installments over a period of time. The monthly amount due could be calculated according to actual power savings or at a fixed rate according to agreement between the company and the customer that could include a maintenance fee and warranty for the interactive units. Such arrangements would assure the customer an immediate positive result in savings without the need of initial investment and without the risk of loss in case the failure of new interactive light units too soon or if they do not save as much energy as advertised. The company owning the interactive units would have a profitable contract and may receive a bonus based on the customer's power savings. In case the customer fails to pay the bill the company would be able to dim the interactive light units or even switch them off remotely or otherwise reduce or prevent the operational functions or performance of the interactive units. To prevent the customer from just switching off the controller, the interactive units could be programmed so that if they lose communication with the controller for an extended period of time (due to the customer disabling the controller) they would switch off or dim to a low enough level to be unsuitable for illumination of the customer's premises during work hours but still be safe for humans to be present inside the building. Once the customer paid the bill a remote command would re-enable the interactive light units to operate normally.

The interactive control system could further manage the operational functions of interactive units integrated with appliances, office and medical equipment and other electrical devices to for example reduce power output during off peak hours or shut down unnecessary systems overnight or during power fluctuations or outages to protect them from power surges. The devices may be integrated with the interactive technology as described herein or control interface units may be used to provide the communication and control to adapt the devices to be controlled within the interactive control system.

The present invention is related to an interactive control system comprising a control unit; an electrical device; at least one interactive unit having embedded control circuitry connected to the electrical device; and wherein the control unit establishes communication with the embedded control circuitry of the at least one interactive unit to control electrical power to the electric device. The control unit of the interactive control system may communicate with the at least one interactive unit through electrical power lines within a building and/or through wireless communication. The electrical device of the interactive control system may be one of a lighting system, an appliance, a piece of office equipment or a medical device. The remote interactive unit with embedded control circuitry of the interactive control system may further comprise an address number and/or group number and the electrical device group number that is dependent on the operational functionality of the electrical device within a programmable network. The interactive unit having embedded control circuitry within the programmable network may be displayed graphically on a display screen of a digital device that provides for the electrical device to be manually configured by a user through a series of menus and buttons to control the electrical device according to the user's desire. The control unit of the interactive control system may be a programmable actuator that replaces traditional physical electrical switches to control the electrical device within the programmable network. The interactive control system may further comprise a plurality of electrical devices each connected to at least one interactive unit having embedded control circuitry; and the control unit may operationally control the plurality of electrical devices within the programmable network simultaneously. The control unit may simultaneously reduce power output to the plurality of electrical devices within the programmable network for non-payment of fees. The plurality of electrical devices of the interactive control system may be a plurality of LED lamps and the control unit may simultaneously command one or more of the plurality of LED lamps to sequentially turn on and off the LED lamps based on a display pattern. The control unit may implement configurable illumination plans that vary according to the season of the year and time of the day to maximize energy savings, user comfort and safety. The programmable actuator of the interactive control system may be automatically configured by a series of commands issued by the control unit running specially designed interactive software.

The present invention is further related to an intelligent interactive control system that comprises at least one interactive unit having interactive control circuitry; an actuator that communicates with the at least one interactive unit; a control unit that communicates with the actuator; and wherein the control unit implements advanced control strategies that enable the at least one interactive unit to operate under programmed electrical conditions. The intelligent interactive control system may further comprise a management system that allows a third party to fully utilize the intelligent interactive control system while the management system retains operational control of the system to, if necessary ensure payment by overriding users commands and settings to reduce performance or disable at least one interactive unit within the system. The intelligent interactive control system may further comprise configurable illumination plans that vary according to one of at least the season of the year, the time of the day, the available power in the case of a power outage to maximize energy savings, user comfort, and safety. The interactive unit of the intelligent interactive control system may be at least one control interface unit that communicates with an electrical device through an AC mains power distribution network to receive commands from the control unit and/or actuator.

The present invention is further related to a method of interactively controlling an electrical device comprising the steps of integrating an electrical device with embedded interactive control circuitry; communicating with the electrical device with the embedded interactive control circuitry using an actuator; communicating with the actuator using a control unit; and controlling the operation of the electrical device with embedded interactive control circuitry with the control unit based on one of least the environment, the season of the year, the time of day or monetary considerations. The method of interactively controlling an electrical device may further comprise the steps of controlling a plurality of electrical devices with embedded interactive control circuitry within an interactive network with each of the plurality of electrical devices having at least an address and at least a group number. The method of interactively controlling an electrical device may further comprise the steps of installing the interactive network at a third party; managing the interactive network system for the third party; allowing the third party to fully utilize the interactive network while retaining operational control; overriding user commands and settings to reduce performance or disable electrical devices within the interactive network due to non-payment. The method of interactively controlling an electrical device may further comprise the step of configuring illumination plans for the interactive network that vary according to one of at least the season of the year, the time of day, the available power due to a power outage to maximize energy savings, user comfort, and safety.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a perspective view of a first embodiment of a control unit of the present invention;

FIG. 2A is a perspective view of a first embodiment of an interactive light unit of the present invention in a cylindrical housing akin to a standard fluorescent light housing;

FIG. 2B is a perspective view of a first embodiment of an interactive light unit of the present invention in a bulb housing akin to a standard incandescent light bulb housing;

FIG. 3 is a block diagram of an embodiment of the interactive control system of the present invention;

FIG. 4A is a perspective view of a first embodiment of an actuator of the present invention;

FIG. 4B is a perspective view of a further embodiment of an actuator of the present invention;

FIG. 5 is a perspective view of a first embodiment a control interface unit of the present invention;

FIG. 6 is a diagrammatic view of an embodiment of the interactive control system of the present invention;

FIG. 7 is a flow diagram of an embodiment of the operational controls of the interactive control system of the present invention;

FIG. 8 is a diagrammatic view of an embodiment of a building displaying a pattern using the interactive control system of the present invention;

FIG. 9 is a diagrammatic view of an embodiment of a building displaying text using the interactive control system of the present invention; and

FIG. 10 is a diagrammatic view of an embodiment of the actuator display of the interactive control system of the present invention.

### DETAILED DESCRIPTION OF THE INVENTION

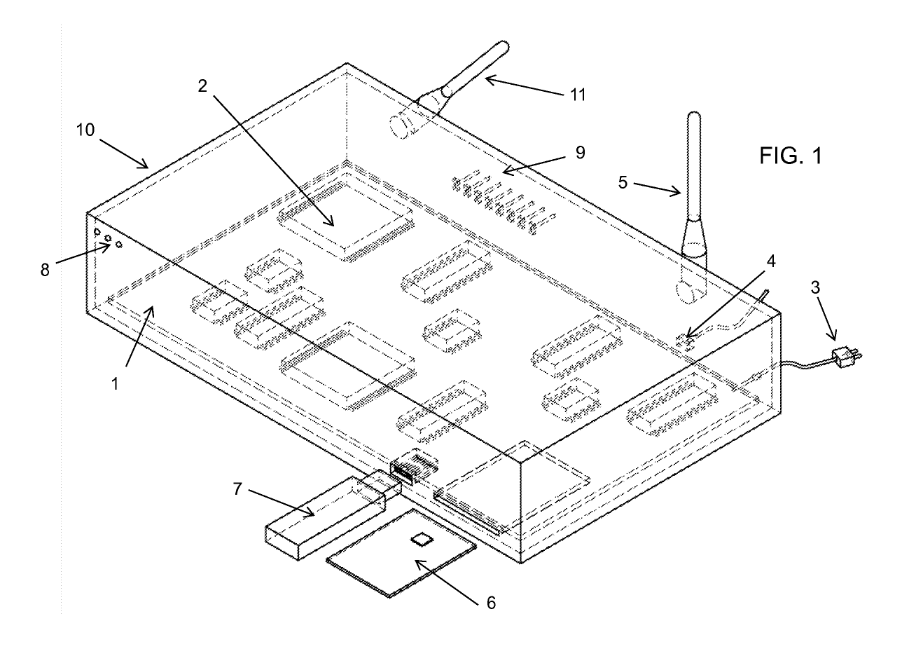

The controller or control unit 10 as shown in FIG. 1, is basically a custom computer system, containing an electronic mother board 1 with a microprocessor 2 and all necessary electronics such as memory, input output interfaces, sensors, and other components. It operates with normal AC power 3 or battery power and has internet connections that may be using network cables 4 and/or wireless communication 5. It can communicate with the remote interactive units and actuator units using the alternating current (AC) electrical power lines 3 within one or more buildings, internet network cables 4, wireless communications 5 or a FDM (frequency division multiplex) wireless interface 11. It is constructed to be packed in a small box similar in size and shape to a decoder used in cable TV operation. The box may have a slot for a smart customer card 6 containing a memory chip to be inserted allowing for the identification of a customer and/or an interface to USB memory sticks 7 enabling information to be easily inserted into the system. It also has indicative lights 8 for power, communication and general alarm to enable the user to easily get critical information and react accordingly.

General purpose analog and digital interfaces 9 are available in the controller 10 to allow it to interface to other systems that may already be installed at the site or that may be installed in the future. These systems can also be connected to a control interface unit 80 that communicates with the controller 10 through the main power lines, internet or wireless communication interfaces. The control interface unit 80 provides an interface to use the system for appliances, office and medical equipment and other electrical devices within the interactive system through the electrical power lines or AC mains 35. The control interface unit 80 may further allow the controller 10 to collect a wide variety of information and be able to take appropriate action depending on ordinary external circumstances such as availability of natural ambient light, reported by one or more light, temperature or other sensors, and also respond to extraordinary or emergency situations such as fire, burglary detection, power fluctuations, emergency power being provided by a generator/no break in operation, or other environmental conditions.

Specific software written to run on a computer or smart phone is used to communicate with the controller 10 allowing advanced features to be accessible by the user such as the ability to graphically display information, audit and change configuration information, program a group of interactive light units to behave as one, program patterns, or perform other operations using the control unit 10. To improve safety, the control unit 10 has an access system requiring a user name and password to allow, restrict or limit access to certain functions. The users have different categories and privileges in a similar way to modern computers and the system may report any failed login attempt to an administrator and other users through a wired or wireless transmission and/or through data logs accessible on the control unit after login by an authorized user. Additional safety measures are also in place such as data encryption, a configurable time delay until the next possible login attempt after each unsuccessful login attempt to prevent brute force attacks, an alarm light that will be lit in a easily visible location at the control unit 10 in case any unsuccessful login attempt has occurred until it is acknowledged and cleared by a route level administrator or user with this privilege.

The control unit 10 comes from the factory with a route administrator user preconfigured with a default password. Upon first use this administrator user will be used to configure additional users of different categories with each category having their particular privileges and access to different functions of the system. The route administrator should only be used by qualified personnel and preferably only for system configuration, upgrades and changes. For safety it is recommended that only one person has access to the route administrator user and the factory default route user password be changed as soon as possible for security.

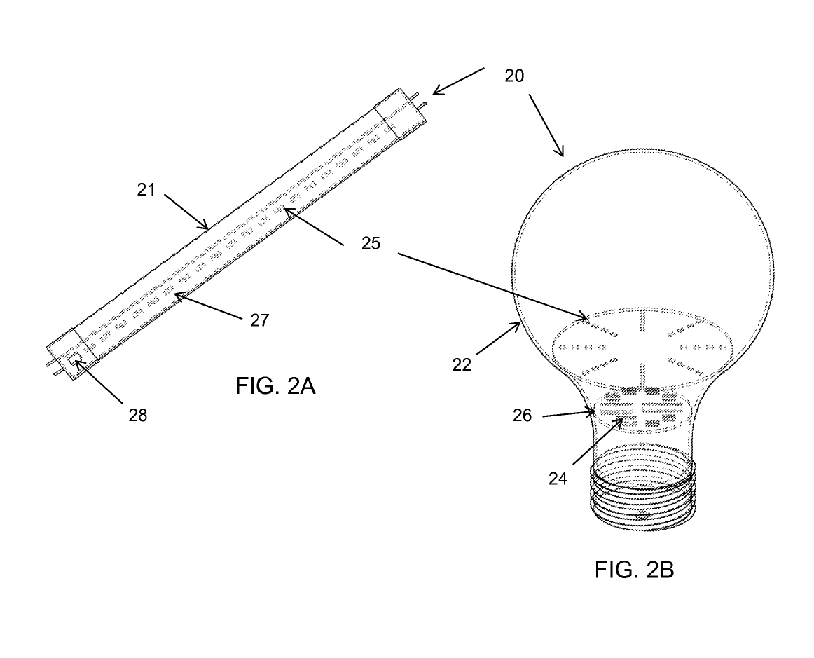

The interactive light units 20 as shown in different embodiments in FIGS. 2A and 2B are manufactured by installing circuitry to an LED lamp. The interactive light unit 20 may be installed in different housings to replace conventional lamps such as a fluorescent type housing 21 as shown in FIG. 2A and an incandescent type housing 22 as shown in FIG. 2B. At the time of manufacture, a small interactive microcontroller and necessary peripheral circuitry are installed to receive commands from the control unit 10 and/or actuator units 50 and implement all intended action on the interactive light unit 20 such as switch it on and off, dim, vary color or light temperature, or perform other features. The interactive circuitry can be implemented using electronic components 24 that are assembled in a circuit board 26 in a standard manufacturing process. The interactive circuit board 26 may be independent from the circuitry containing the LED devices 25 as shown in FIG. 2B or may be configured on the same circuitry platform 27 containing the LED devices 25 that produce the light. In further embodiments, if space requirements or production volumes justify, all the necessary circuits may also be integrated into a custom interactive circuitry chip 28 as shown in FIG. 2A.

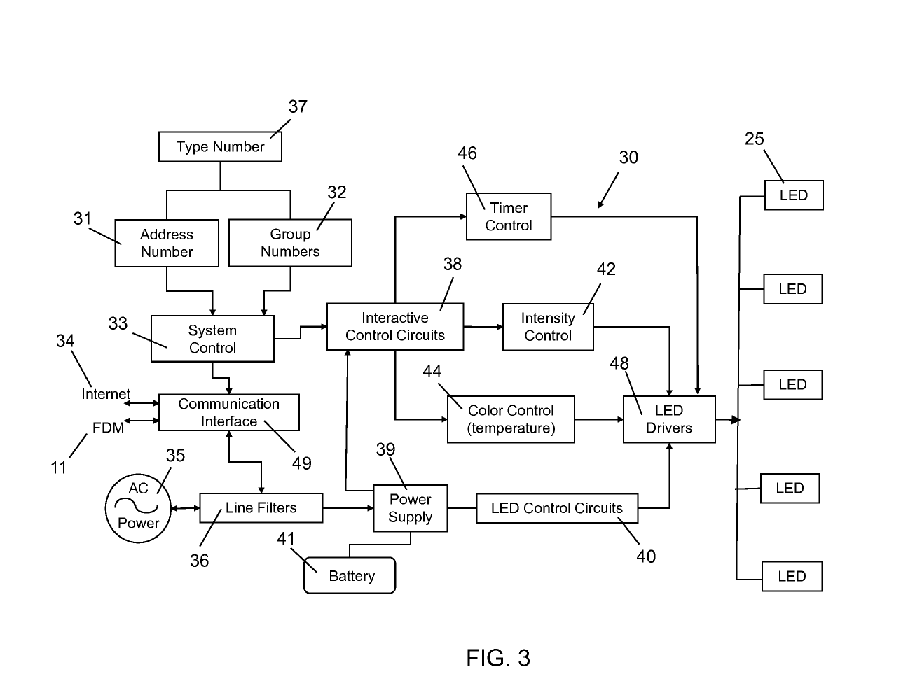

The additional embedded interactive circuitry integrated into the LED lamp interfaces with the existing LED circuitry in such a way to provide the intended degree of control. A block diagram of an embodiment of the interactive circuitry 30 capable of implementing the required functions is shown in FIG. 3. A unique address number 31 for each device is set at the time of manufacture or is programmed using the controller 10 to provide for the controller to identify each Interactive Light Unit (ILU) 20 and to communicate with a number of devices simultaneously and/or issue commands to specific units. Since the number of bits necessary to identify the number of groups 32 of lamps on a particular installation will be much smaller than the number of bits allocated to the lamp addresses 31, once the units are detected and identified they are assigned to groups consisting of one or more lamps. The system control 33 stores each address number 31 with the group numbers 32 of all groups to which the unit has been assigned and responds to commands issued to these groups. These commands can arrive and be sent through the AC mains 35. Arriving commands once filtered from the power supply are decoded by the communication interface 49. The communication interface 49 also can receive and transmit commands through the internet 34 (either by cable 4 or wireless transmission 5) or through a wireless FDM interface 11.

The AC power supply with appropriate line filters 36 and/or a battery 41 supplies a power supply 39 to accommodate the interactive and LED circuits. The system control 33 receives commands from a controller 10 or actuator units 50 through the communication interface 49. If a command has the address of the specific ILU 20, the system control 33 processes and directs the command to the embedded interactive control circuit 38 that interfaces to the LED control circuitry 40 to implement the appropriate action. A simple LED lamp with only on/off control is enhanced with circuits to control intensity (brightness) 42, color (temperature) 44 and a timer 46 may be added to allow those functionalities. Adjustments to these settings and functions are fed to the LED drivers 48 to modify the illumination characteristics of the array of LED devices 25 on the addressed interactive light unit 20.

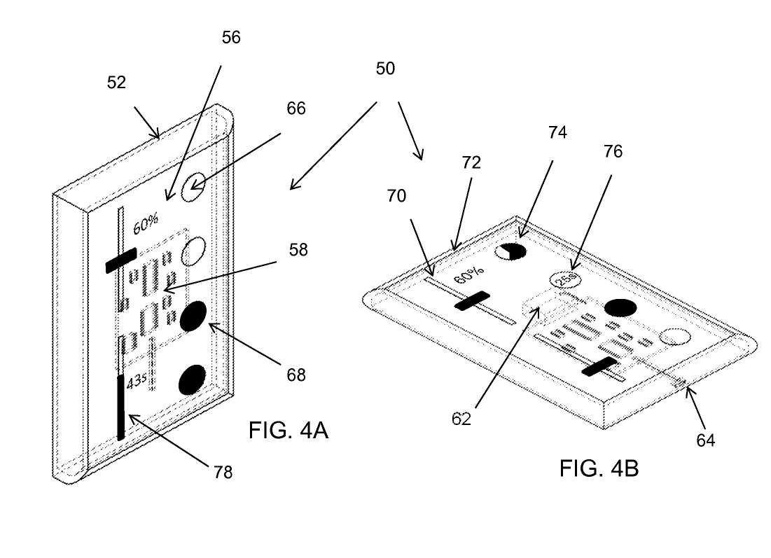

Actuators units 50, as shown in FIGS. 4A and 4B, are designed to replace the traditional on/off switches or dimmers that control traditional lamps. They can be constructed to be wall-mounted 52 or portable 54. They are made using a general purpose display with touch screen capability 56. An electronic board 58 with all necessary circuits provides the capability to communicate with the control unit 10 and interactive light units 20 over the AC mains 35, internet 34 or FDM 11. The wall mounted version 52 has wires 60 to be connected to the AC mains 35 and the portable version 54 is fitted with a rechargeable battery 62 and a charger inlet 64 that can be designed to accept a standard USB charger or AC power.

The actuator unit 50 displays an icon for each interactive light unit or group of interactive light units 20 that is assigned within the interactive control system 60. A simple icon 66 is used to indicate standard on/off operation. When one interactive light unit 20 or group of interactive light units is switched on the icon is highlighted 68. Depending on the configuration and LED circuitry capability other icons can be displayed such as a dimmer bar 70 that depending on configuration can be associated with a numeric indication of the selected luminosity level 72. In the application of a timer operation, the timer icon displays the remaining time by means of a pie chart 74 and/or number 76. Also a reducing bar 78 or other graphics with various functionality can be configured.

Fully compatible and interchangeable monochromatic and color versions of actuator units 50 may have different display sizes to display a higher or smaller number of controls that may be offered. Variability in features and functions allows the user or customer to freely select what type of actuator 50 to install in each specific location to use as remote controls choosing between cheaper or more sophisticated versions depending on the needs and budget. Actuator units 50 do not control the interactive light units 20 by means of physically changing their electrical connection to the AC mains 35 or interrupting the circuit such as in the operation of a traditional switch. Instead the actuator 50 simply sends a command to the control circuitry telling a specific interactive light unit 20 or group of interactive light units to perform the required operation and the selected unit(s) implement the command. The interactive light units 20 remain connected to the AC mains 35 at all times. That allows the system to be easily reconfigured without the need to redirect wires and also allows the user to assign an interactive light unit or group of interactive light units 20 to be controlled by several actuators 50 in whatever manner is most convenient. To implement such a control scheme in traditional installations is very difficult because the number of return wires and poles of the switches necessary to implement the circuit grows very quickly beyond practical constraints.

The actuators 50 can be made in several different configurations. The actuators 50 can be constructed to be physically mounted to a wall or fixed at any specific location for convenience and may be permanently connected to the AC mains 35 for its power supply or as an independent device that has its own rechargeable battery that the user can place anywhere that is convenient or that can be carried by the user as he moves around. The operations of the actuator unit 50 may further be implemented on any mobile or digital device through a software application such as on a smartphone, iPod, iPad, tablet computer, laptop or other device that can be used as a processing unit, a display unit, and as a service offered via the World Wide Web.

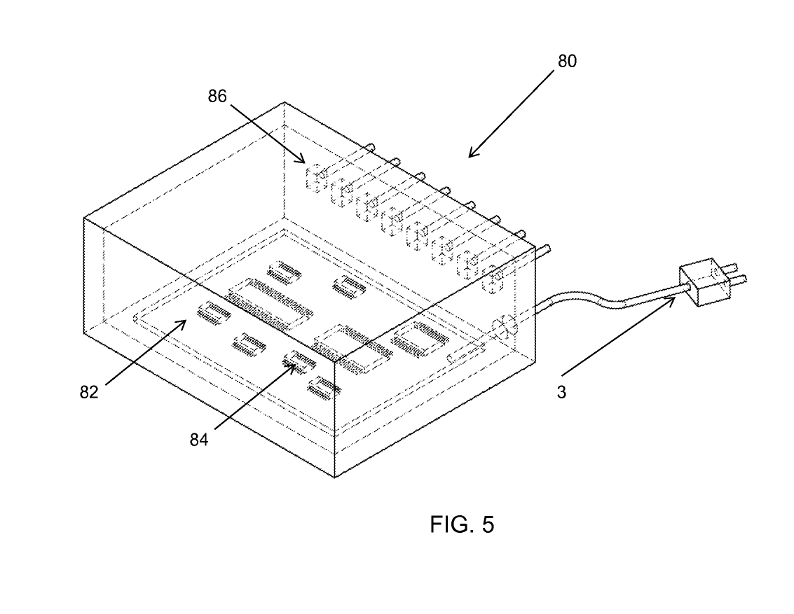

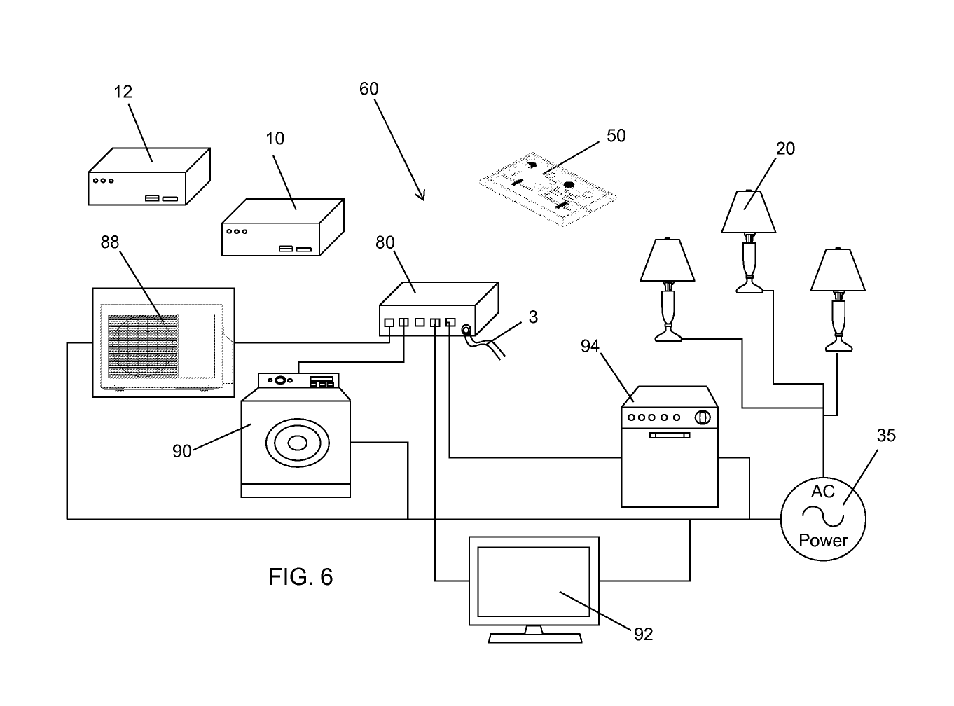

The control interface units 80 as shown in FIG. 5 are units intended to expand the operational functions and possibilities of the system. The control interface units 80 operate as interfaces so that devices that do not have embedded control circuitry can be integrated to the network and be controlled by the control unit 10 and/or actuator unit 50. These devices may be any electrical device such as electrical appliances, computers, copiers, monitors, other office equipment and medical devices that can be added to the system and be controlled to the necessary degree. The control interface units 80 are composed of a board 82 with the same basic electrical circuits 84 to enable information exchange used in the interactive light unit 20, controller 10 and/or actuator 50 and additional input/output digital and analog interfaces 86 to collect information and control the intended device. Such devices 80 could be for example luminosity detectors, sound producing units to be used as audible alarms, power usage indicators, a general purpose switch to allow the system to switch on and off any device for example to protect it in case of power fluctuations or cope with power limitations imposed by the available emergency generator during a power outage. The control interface units 80 allow the system to manage a wide variety of devices once the necessary information is configured by the user into the software. The control interface units 80 are connected to the AC mains 35 as shown in FIG. 6 and communicate with the controller 10, appliances or other devices through this connection. The control interface units 80 can also communicate with the control unit 10, appliances or other electrical devices using wireless communication.

Control interface units 80 can also be integrated into one custom chip as previously described for the interactive light units 20 and be integrated into any of the appliances such as an air conditioner 88, washing machine 90, television 92, dishwasher 94 and other devices. Control interface units 80 or the interactive appliances fitted with the chip are manageable using the control unit 10 in the same way as an interactive lighting system 20. The user can then configure special utilization plans for these interactive units, for example to reduce the power consumption of the air conditioning during peak hours or to program the wash cycle for a more convenient time, or use an actuator unit software application on a mobile phone to see if a particular device or lighting system has been left on at home and perform many more operations. In this way starting with the interactive light units 20, the user can build up a very sophisticated interactive control system 60 for all lighting, electric appliances, office equipment or medical devices in the home or office by adding on new interactive devices at once or slowly one at a time as old units are replaced with new interactive ones fitted with the technology.

Traditional lamp switches and circuit breakers can also be used for safety and as a means to completely switch off one or more interactive units according to best engineering practices for electrical installations. Switching off the interactive light units 20, actuators 50 and control interface units 80 or other interactive devices does not affect the operation of the system. All configured information is stored in persistent memory so that it will not be lost in case of power failure or if the interactive units are switched off using normal switches or circuit breakers. When power is restored or the interactive units are switched on again they resume normal operation such as going back to their last state prior to loss of power. Each individual system (controller 10, interactive light unit 20, actuator 50 and control interface units 80) has its unique identification number 31 by means of a one-time programmable number burned at the factory or programmed using the controller 10. This identification 31 may be an alphanumeric code that is reported to the control unit 10 and stored in a table. Every time the control unit 10 needs to communicate with an individual unit in the system (slave controller 12, interactive light unit 20, actuator 50, control interface unit 80 or other interactive device) it will consult this table. Each unit also has its own type number indicator 37 that allows the controller 10 to properly identify each unit and the software to retrieve unit characteristics such as physical shape, power consumption, available commands, and other operational features and specifications of a particular device. The control unit 10 may communicate with other units in the system using preferably a small amplitude high frequency signal over the mains 35, or alternatively using wireless transmissions such as WIFI, Bluetooth, FDM or infrared. Appropriate filters and bypasses may be installed at circuit breaker boxes to allow access to all circuits.

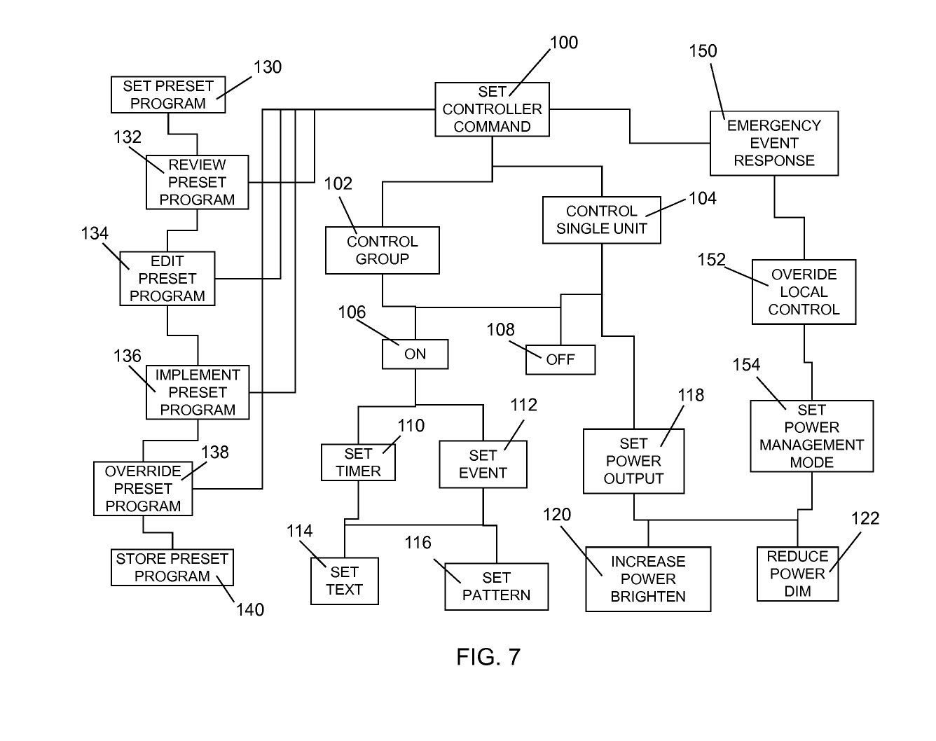

An embodiment of operational commands for the controller 10 is shown in FIG. 7. These commands 100 include selection of a control group 102 or a single unit 104, powering a unit on 106 or powering a unit off 108, setting a timer 110 to perform an operation at a later time or for a certain period of time, setting an event 112 that may set text or a pattern 116 of, for example the interactive light units 20 to display an advertisement, a celebration of the event or holiday, a warning or other information or artistic design. Additional information can be preset or programmed into the controller 10, interactive light unit 20, actuator 50 or control interface unit 80 using communication software developed for the interactive control system 60 on a computer, smart phone, tablet or other digital device. A program 130 developed on, for example an actuator 50, and stored 140 may be reviewed by the controller 132, edited by the controller 134, implemented by the controller 136, or overridden by the controller 138. Particularly in an emergency event response 150, a preset program on a controller 10, an interactive light unit 20, an actuator 50, a control interface unit 80, or any local control 152 may all be overridden to put the system in a power management mode 154 and for example reduce the power output 122 and shut down unnecessary electrical systems. The ability to develop preset programs on any unit or group of interactive units within a system 60 allows for the system 60 to implement advanced features to enhance operational control and efficiency of energy use within the system. These features may include the following:

Configure groups. One or more group numbers can be assigned to each individual interactive unit so that they are able to respond immediately to a single command from the controller 10 if any one of the groups it belongs to is addressed.

Timer mode. Interactive light units 20, control interface units 80 and other interactive devices can be configured to operate in timer mode. A user defined time for each individual unit or group of units can be set allowing light units 20 and interactive devices to switch on or off automatically after the preconfigured time has elapsed.

Reprogram actuator. The user may be allowed to reprogram the actuator 50 so that one actuator 50 can be used to switch on and off or dim a specific interactive unit or group of interactive units.

Preprogram Interactive Units. Interactive units can be programmed to respond only to a specific actuator 50 or set of actuators (or to ignore commands from any actuator and remain lit at all times) by any user having configuration privileges and will from then on only respond to the appropriate actuators 50. Only users with equal or higher priority can override configuration commands, none being higher than the route administrator.

Special illumination plans. Illumination plans can be implemented to accommodate for variations in electricity cost according to seasons of the year, summer/winter time or wet and dry seasons to maximize savings and user comfort.

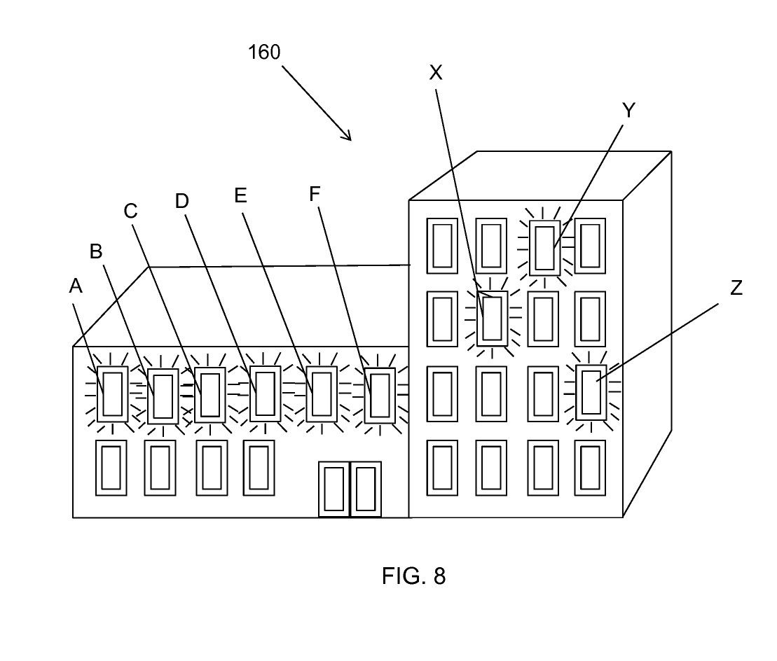

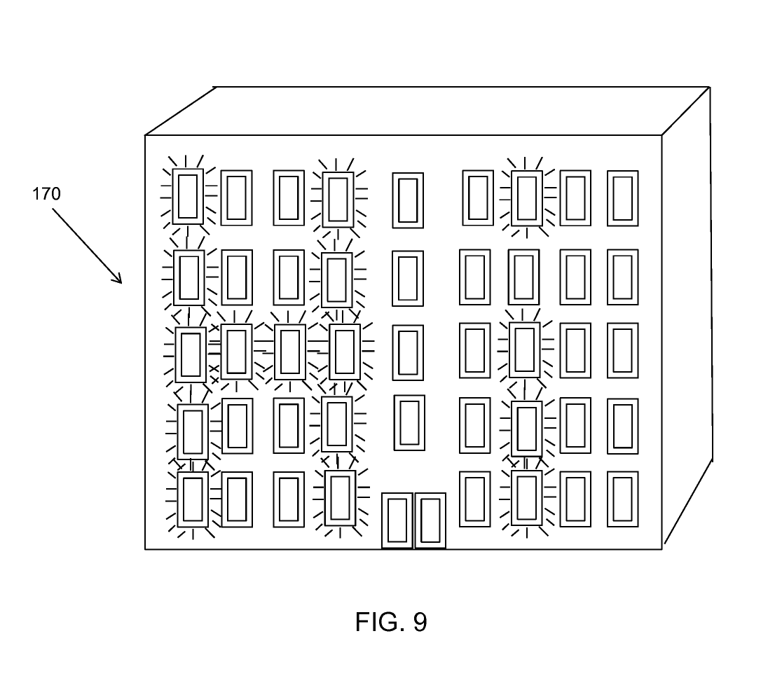

Special occasion plans. Similarly to the previous item, special illumination plans can be programmed for special occasions such as anniversaries, Christmas, New Year or festive days. Such plans could enable home users to dim or blink a set of interactive light units 20 to create a special atmosphere and offices to use the light units 20 in their façade to display static or moving patterns or even text messages depending on specific size and shape of the building. As shown in FIG. 8, a special illumination plan for a building 160 may sequence a series of interactive light units 20 indicated as A-F turning each on and off consecutively or randomly turn lights on and off indicated as X-Z in each room of the building 160 to create an unusually eye-catching effect. In further embodiments as shown in FIG. 9, a group of interactive light units 20 within a building 170 may be turned on to display a text message such as Hi or an advertisement, Christmas tree or company logo on the façade of the building 170.

Preconfigured emergency illumination plan. In case of power loss if an emergency backup generator and/or a no break battery operated system is available the controller 10 will send a single command and quickly switch off all non-essential interactive units and/or dim those that are on to reduce power usage and manage the situation as well as possible according to the available emergency power and time of the day and year. That allows the home, office or factory where the system is installed to easily implement an intelligent emergency light system without the need of making big and costly modifications to the electrical installation and wiring.

Other emergency events. Similarly to the previous item, emergency plans can be programmed for other critical events such as fire, non-authorized entry or burglary detection, power fluctuations, or other events. Such a plan could for example make light units near exits blink and/or light to illuminate a path leading to an exit. The light units may be located at the floor or ceiling to illuminate and blink in a sequential way to facilitate evacuation in case of fire or switch on all light units at maximum illumination and blink selected external light units and, if available, trigger an audible alarm to attract external attention and help in case of burglary detection.

### Configuration and Operation of the Units and System:

The interactive units or control interface units 80 are able to operate either as stand-alone or in intelligent mode. Unless properly configured at installation or at a later time, any interactive unit will simply behave in normal stand-alone mode, switching on and off when power is applied or removed and operating as any other traditional lamp, appliance or equipment. This allows the factory to reduce production costs by standardizing production at the factory and to avoid unnecessary changes or additional configurations at the time of manufacture. The user can also use purchased interactive devices in a simple traditional installation and decide only at a later time to configure a system 60 and if he so wishes to introduce other devices into it to be able to use the advanced features and benefits of his already available interactive light units 20, control interface units 80 and other interactive devices.

The configuration of the system 60 is designed to be as easy and straight forward as possible. Upon being connected to the AC power, interactive units will enter stand-alone mode and simply behave as normal lamps, appliances or electrical equipment switching on and off according to available AC power 35 until they receive a command. Actuator units 50 when first turned on or connected to the AC power 35 will enter configuration mode, display the configuration icon and wait for user confirmation of manual configuration or for received commands from the Control Unit 10. Once an actuator 50 has been configured and has been assigned to at least one interactive unit, it will no longer display the configuration screen and when AC power 35 is cycled, it will instead display the control screen 56 showing all configured control icons.

Once the user confirms the manual configuration, the actuator 50 will send an information request command informing its own address. That will cause all connected interactive light units 20, control interface units 80 and/or interactive appliances and electrical equipment receiving the command to respond informing their type identification 37 and their address 31. In an embodiment, each interactive unit receiving the information request command will first wait a random number of power cycles and then transmit and wait for acknowledgement. If the acknowledgement is not received it will wait again and then transmit its information until the ongoing communication is completed. Alternatively, other communication protocols may be implemented dependent upon the configuration of the interactive device.

Once the actuator unit 50 receives the information from an interactive light unit 20 or other interactive device it will send an acknowledgement message with the received address of the interactive light unit 20 or device that sent the message. This will cause the corresponding interactive unit to stop transmitting its address until receiving another command. In this way, the request information procedure will continue until each of the interactive units have been addressed and acknowledged completing the procedure.

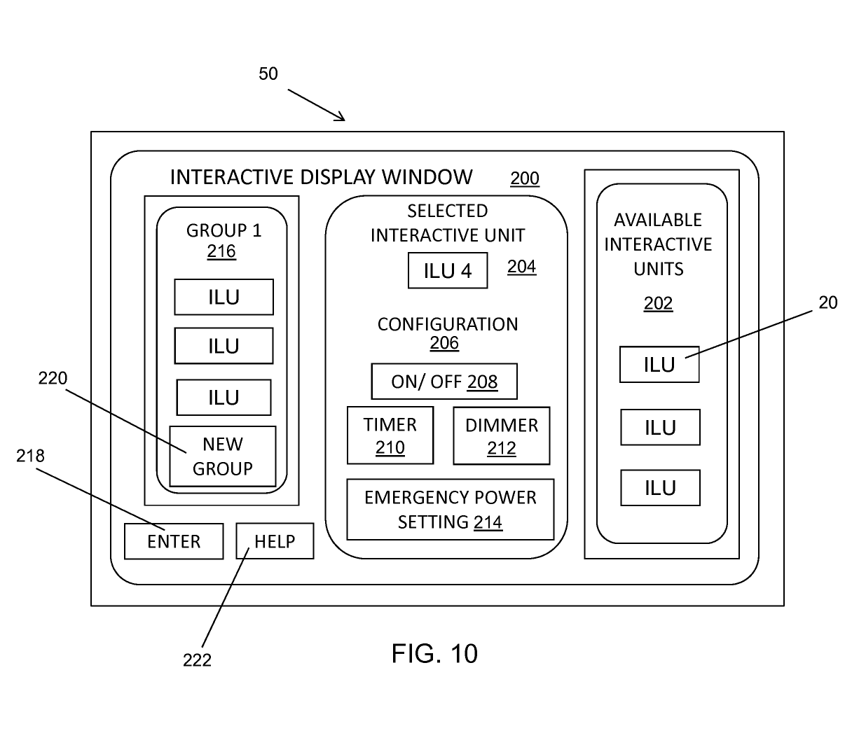

The actuator 50 will then prepare a list with each of the interactive unit addresses that are available within its transmission area, automatically create a group and command the first interactive unit on the list or for example the unit in closest proximity to the actuator 50 to start blinking or to perform another test sequence to confirm operational function and communication with the actuator. During the test operational sequence as shown in FIG. 10, the actuator 50 will display icons or other indicators on an interactive display window 200 that presents all available interactive units to the user. The user will then see if he wants a particular interactive unit to be controlled by that actuator 50 and if so confirm the selection of the interactive unit by selecting the unit icon, menu item, or other indicator and for example highlighting it, or dragging and dropping it into the selected interactive unit display 204. A configuration window 206 will be displayed offering the possibility of power on or off 208, setting a timer 210, setting a dimmer control 212, and/or entering an emergency power setting 214 or other operational features. The emergency power setting 214 provides for the user to configure the interactive light unit 20 or interactive device to remain on as essential lighting or equipment such as maintaining power to a medical device such as an oxygen machine in the event of a power outage. The operational features are dependent on the possibilities that a particular interactive unit offers according to its type identification 37 so the user can choose what operational functions for the interactive device he wants. In case of timer operation 210 he informs the number of hours, minutes or seconds or at what time the interactive light unit 20 will be lit or the time to turn on an interactive appliance or other electrical unit once commanded.

The user will then be able to select other interactive light units 20 and interactive devices for group operation by touching the group icon or dragging the interactive unit icon into the group display window 216 and confirming the acknowledgement of other interactive units into the current group. Only compatible interactive units that offer the same control options selected for a specific group will be accepted, and the actuator 50 will automatically skip incompatible ones. Once the user is satisfied he presses the enter icon 218 and the window may close and/or direct the user to the available interactive units display 202. A help icon 222 may also be provided to assist the user in system commands and operation.

If the user does not want to include the currently blinking interactive light unit 20 or interactive device, he selects the next icon and the actuator 50 stops signaling the current interactive unit and starts blinking or sequence testing the next one. This operation will be repeated until all interactive units have been skipped or confirmed and configured into a group that will have at least one interactive unit and up to all units present.

After the first group is created, the user can create additional groups by touching the new group icon 220 in the group display window 216. The user can create as many groups as he wants (limited only by the available actuator memory) with at least one interactive unit in each group and additionally any combination of the remaining available units. If the user makes a mistake or wishes to change a group or configuration, he can navigate through the group display window 216 to identify the interactive unit to include or remove from a group by running a test or sequence and checking which unit is blinking or for example producing an audible sound for identification and confirming the operation. Groups may also be edited to change the control options or operational features and if these changes remove the compatibility of an interactive unit within the group, the actuator will automatically remove interactive units that do not offer the newly selected control option from that group.

Using the actuator 50 touch screen in a first embodiment, the user may change the configuration of interactive unit at any time by accessing the configuration window 206. The configuration window 206 may be accessed by for example touching anywhere on the screen and holding for 10 seconds (or a configurable time) and then tapping on the configuration icon that will be displayed on a different spot than where he initially touched. The interactive display window 200 will be displayed and the interactive units assigned to the first group will start to blink or produce an audible sound. Once the configuration changes are completed the actuator 50 will display the interactive display window 200 with the newly configured group of interactive units highlighted.

In the simplest possible case, the system 60 will be composed of just one interactive unit and one actuator. In this case once the user completes the configuration procedure, the actuator will display a single icon for that particular interactive unit that will be controlled only at that point. If the user wants the functionality of additional groups with different control options and configurations for that single interactive unit may be implemented. For example timer operation and dimmer controls that operate based on a special event setting. For these new configurations multiple icons will be displayed in the interactive display window 200. The user will be able to select any icon at any time for any interactive unit and the current selected control option will override the previous one.

If a second interactive unit is available the user will have the choice of including both interactive units into one group or creating two independent groups. He can also create additional groups with different control options as described previously. If a second actuator 50 is introduced, it will be configured following the same procedure as described above. If an interactive unit or group of interactive units is configured into two or more actuators, it will be possible to control the units from any one of the actuators 50 where it is configured. In that case the user will be able to dim or switch interactive units on and off from multiple locations. In case of timer operations, a different time may be assigned to the same interactive unit or group of interactive units for every actuator giving the user the flexibility to alter their behavior depending on the geography of the room and his convenience.

The actuator 50 will create one icon for each group that the user configures. If there are too many icons to display in the available screen area, icons will be moved into additional pages that can be accessed by swiping the screen. The user can organize the icons in any order he finds convenient in multiple pages that do not need to be full and can have as little as one icon within a page or display. That may be a desirable thing to do for example configuring pages for each room or area in a house or office in a portable actuator unit 54 the user wants to use as remote control.

The same is also possible for wall mounted actuator units 52, however, for practical reasons it is recommended that wall mounted actuators 52 be configured with as few pages as possible, preferably one because the actuator 52 is associated with the interactive light units 20, or interactive appliances, office equipment or medical equipment within a room, area or location. In further embodiments, the actuators 50 can have any size screen or the actuator specially designed interactive software application can be integrated on a computer platform, mobile phone, tablet or other digital device and be displayed on a large screen computer monitor to accommodate buildings and areas having numerous interactive units each with icons or indicators within the screen. Additional wall mounted actuators 52 may also be incorporated for very large rooms or areas.

The system can be scaled up to any arbitrary number of interactive units, actuators 50, and other interactive devices. If a large number of interactive units and actuator units 50 are installed, one or more control interface units 80 may be required and if the user wants to access special functionalities or use advanced control strategies, one or more control units 10 may be required to assist the user in maintaining and properly accessing all devices within the system.

Control units 10 provide more flexibility for the system by creating the possibility of multiple layers of commands. The control unit 10 can assign interactive units to a group defined by users with different priorities. For example, the route administrator possesses the highest priority, followed by administrators, users and guests. Guests do not have access to configurations and can only issue commands using objects that have already been configured such as activating a special illumination plan and/or recover reports such as on the current and projected power consumptions, list of defective units that need replacement, or other statistics on operational functions. Users at other levels can issue commands, collect reports and also setup configurations such as create a new group of interactive units, assign the group to one or more actuators 50, create a special illumination plan, configure a control interface unit 80, and perform other higher level functions within the system 60. Access to the system 60 for users may be configured with a login name and password with all commands and changes logged indicating the name of the responsible user and the time the event happened. The log file can be audited later by an administrator or route administrator.

Users and administrators can create multiple configuration schemes suitable for their needs and comfort. Different configurations can be made to maximize savings, comfort or safety taking into account multiple factors such as the season of the year, time of the day, electricity cost at peak hour and off peak hour, and other environmental and location specific functions to optimize system performance. The system 60 can be configured to automatically switch between different configurations according to external factors such as power failure, burglary alarm, fire alarm, ambient temperature or other fault or programmed events.

A user can only apply changes to configurations created by users of the same level or below so no user can change a configuration created by the route user. This can be useful to prevent undesired changes to the system 60 done by accident or on purpose. This hierarchy of users with the highest level being the route administrator provides a platform that can also be used as a means to establish a business. For example, a company can purchase all interactive units and system components and set up and install an interactive system for another company. The receiving company is given levels of access only at a regular administrator level, user level and guest level but not access to the route administrator level. The company owning the interactive system 60 can then setup a management system to manage the configuration settings for the system. This control could be used to set all interactive light units 20 into for example a timed mode so that they automatically dim to 80% of the maximum luminosity after a period of time (for example 2 weeks or 1 month) and keep dimming down until they reach a value that no longer can provide adequate light for work but is still safe for human presence in the building. If the customer keeps paying the required fees in a timely manner such as on a monthly basis, an automatic reset command is sent over the internet before the time elapses, resetting the counter and keeping the interactive light units 20 operating at up to maximum luminosity and the system functioning properly. System safeguards will prevent the customer from disrupting the preset program such as if the customer disconnects the control unit, the interactive light units 20 will no longer be able to receive the time reset command and will dim after the configured period of time elapses. Because this configuration was set up by the route administrator and the company receiving the interactive control system 60 does not have access to this level the configuration cannot be changed. Any failed attempt to log in as route administrator can be made to generate a message to the owner company denouncing any attempt of tampering.

In this way a company can enter a business of leasing interactive systems 60 and share with the company receiving the system 60 the financial result coming from the power savings. The company receiving the system 60 is also benefited by being able to replace all its lighting systems, appliances, office and medical equipment without the need to invest money upfront and basically pay for the fees with the savings it has already made. At the same time it can also benefit from several additional functionalities that can be made available through the control unit 10. The owner company can even create different packages depending on what services are allowed or charge separately for these services. Many other possible agreements can be made.

Once a control unit 10 is plugged into the system 60, it assumes command of the AC power distribution network 35 under its supervision. It inquires for all actuators 50, interactive units and control interface units 80 and produces a list of units with corresponding configuration information already present on the system 60. Further configuration can be made and be sent to any unit amending or replacing manual configuration that had been previously done. Once the list is completed the control unit 10 will cyclically poll each actuator 50 based on adequate polling routines to optimize communication within the system 60. The user will be able to place all detected interactive light units 20, interactive devices, actuators 50 and control interface units 80 into a graphic representing the floor plan of the location where the units are installed for easy reference using the specially designed interactive configuration software running on a smart phone or preferably a tablet or computer system. In case of a large office located in a building, a graphic representation of the façade can also be created. A special illumination plan can then be created using the interactive light units 20 located at the immediate vicinity of windows or purposely installed on the façade to produce patterns that can be seen from the street. These patterns may be animated and produce a Christmas tree, blinking stars, snow or rain drops falling, logos or any other suitable design. Text and moving messages may also be displayed depending on each particular case.

The interactive units can be configured to respond to group commands by issuing a series of configuration commands that do not need to be immediately relayed to all units. After any configuration change the controller 10 will begin to send the necessary commands to all affected units until the update is complete. In case of a large number of interactive units in the system 60 or many control interface units 80 of different types requiring additional information, a short delay may occur in performing this communication but because in basic operation this is a relatively rare event that runs in the background and does not need to be completed in real time a short system delay may be acceptable to provide time for the operation to be completed.

During normal operation, the configuration of group commands and the presence of an adequate number of actuators 50 may result in satisfactory performance levels. In that way a single controller 10 may be able to control a large number of interactive units. However practical limitations may cause the time needed to manage a high number of devices to increase rapidly especially if communicating over a low bandwidth medium such as the AC mains 35 and/or a large volume of configuration or operational data must be exchanged. If wireless communication is used the range may not be sufficient to reach all interactive units in a big building. To circumvent that, slave controllers 12 can be used, dividing the AC mains 35 power infrastructure into two or more areas by means of installing dynamically configurable filters and bridges in circuit breaker boxes so that each controller 10 and 12 is given its own area of actuation with an adequate number of control units within the limits imposed by the desired performance. Different wireless channels can be programmed to achieve a similar effect when using wireless communication.

The master and slave controllers 10 and 12 can then be set to communicate over a high bandwidth channel allowing the master 10 access to all interactive units within the system 60. All relevant information for the system configuration and areas selected for each control unit 10 is mirrored on all control units 10 so that any slave controllers 12 can assume the master role in response to a user command or following a priority list in case of failure of the current master 10 ensuring high reliability and flexibility of operation. In the event of failure of a slave control unit 12, the system 60 can automatically detect the problem and send a command to reconfigure the bridges and filters on the affected circuit boxes so that the orphan units can be momentarily overtaken by another slave controller 12 located in the vicinity according to a contingency plan allowing for continuous access to all interactive units in the system 60 despite some performance degradation that may be inevitable. A replacement control unit 10 need only to be installed at the proper location and once powered up the new control unit 12 will automatically identify the master controller 10, download the configuration maps and upon verification of the individual addresses of the orphaned interactive units within its controlling range, automatically identify its role and assume the functions of the previous slave control unit 12 that was replaced.

Since certain changes may be made in the above-described invention, without departing from the spirit and scope of the invention herein involved, it is intended that all of the subject matter of the above description or shown in the accompanying drawings shall be interpreted merely as examples illustrating the inventive concept herein and shall not be construed as limiting the invention.

What is claimed is:

1. An interactive control system comprising:
a control unit;
an electrical device;
at least one interactive unit having embedded control circuitry connected to the electrical device; and
wherein the control unit establishes communication with the embedded control circuitry of the at least one interactive unit to control electrical power to the electric device.

2. The interactive control system of claim 1 wherein the control unit communicates with the at least one interactive unit through electrical power lines within a building.

3. The interactive control system of claim 1 wherein the control unit communicates with the at least one interactive unit through wireless communication.

4. The interactive control system of claim 1 wherein the electrical device is one of a lighting system, an appliance, a piece of office equipment or a medical device.

5. The interactive control system of claim 1 wherein the remote interactive unit with embedded control circuitry further comprises one of at least an address number and group number.

6. The interactive control system of claim 5 wherein the electrical device group number is dependent on the operational functionality of the electrical device within a programmable network.

7. The interactive control system of claim 5 wherein the at least one interactive unit having embedded control circuitry within the programmable network is displayed graphically on a display screen of a digital device that provides for the electrical device to be manually configured by a user through a series of menus and buttons to control the electrical device according to the user's desire.

8. The interactive control system of claim 5 wherein the control unit is a programmable actuator that replaces traditional physical electrical switches to control the electrical device within the programmable network.

9. The interactive control system of claim 5 further comprising a plurality of electrical devices each connected to at least one interactive unit having embedded control circuitry; and
wherein the control unit operationally controls the plurality of electrical devices within the programmable network simultaneously.

10. The interactive control system of claim 9 wherein the control unit simultaneously reduces power output to the plurality of electrical devices within the programmable network for non-payment of fees.

11. The interactive control system of claim 9 wherein the plurality of electrical devices are a plurality of LED lamps and the control unit simultaneously commands one or more of the plurality of LED lamps to sequentially turn on and off the LED lamps based on a display pattern.

12. The interactive control system of claim 11 wherein the control unit implements configurable illumination plans that vary according to the season of the year and time of the day to maximize energy savings, user comfort and safety.

13. The interactive control system of claim 12 wherein the programmable actuator can be automatically configured by a series of commands issued by the control unit running specially designed interactive software.

14. An intelligent interactive control system comprising:
at least one interactive unit having interactive control circuitry;
an actuator that communicates with the at least one interactive unit;
a control unit that communicates with the actuator; and
wherein the control unit implements advanced control strategies that enable the at least one interactive unit to operate under programmed electrical conditions.

15. The intelligent interactive control system of claim 14 further comprising a management system that allows a third party to fully utilize the intelligent interactive control system while the management system retains operational control of the system to, if necessary ensure payment by overriding users commands and settings to reduce performance or disable at least one interactive unit within the system.

16. The intelligent interactive control system of claim 14 further comprising configurable illumination plans that vary according to one of at least the season of the year, the time of the day, the available power in the case of a power outage to maximize energy savings, user comfort, and safety.

17. The intelligent interactive control system of claim 14 wherein the interactive unit is at least one control interface unit that communicates with an electrical device through an AC mains power distribution network to receive commands from the control unit and actuator.

18. A method of interactively controlling an electrical device comprising the steps of:
integrating an electrical device with embedded interactive control circuitry;
communicating with the electrical device with the embedded interactive control circuitry using an actuator;
communicating with the actuator using a control unit; and
controlling the operation of the electrical device with embedded interactive control circuitry with the control unit based on one of least the environment, the season of the year, the time of day or monetary considerations.

19. The method of interactively controlling an electrical device of claim 18 further comprising the steps of:
controlling a plurality of electrical devices with embedded interactive control circuitry within an interactive network with each of the plurality of electrical devices having at least an address and at least a group number.

20. The method of interactively controlling an electrical device of claim 19 further comprising the steps of:
installing the interactive network at a third party;
managing the interactive network system for the third party;
allowing the third party to fully utilize the interactive network while retaining operational control;
overriding user commands and settings to reduce performance or disable electrical devices within the interactive network due to non-payment.

21. The method of interactively controlling an electrical device of claim 19 further comprising the step of configuring illumination plans for the interactive network that vary according to one of at least the season of the year, the time of day, the available power due to a power outage to maximize energy savings, user comfort, and safety.
